(19) United States
(12) Patent Application Publication
(10) Pub. No.: US 2016/0160761 A1
(43) Pub. Date: Jun. 9, 2016

(54) Gas Turbine Engine With Single Turbine Driving Two Compressors

(71) Applicant: United Technologies Corporation, Hartford, CT (US)

(72) Inventors: Gabriel L. Suciu, Glastonbury, CT (US); James D. Hill, Tolland, CT (US); William F. Schneider, Cromwell, CT (US); Jonathan F. Zimmitti, Newington, CT (US)

(21) Appl. No.: 14/921,324

(22) Filed: Oct. 23, 2015

Related U.S. Application Data
(60) Provisional application No. 62/089,307, filed on Dec. 9, 2014.

(51) Int. Cl. F02C 7/36; F02C 9/16; F02C 3/04

(52) U.S. Cl. CPC F02C 7/36; F02C 3/04; F02C 9/16; F05D 2220/32; F05D 2260/4031; F05D 2270/02

(57) ABSTRACT

A gas turbine engine comprises a lower pressure compressor and a higher pressure compressor. A single turbine drives both the lower pressure compressor and the higher pressure compressor through a gear reduction. The gear reduction includes an actuator and at least two available speeds, such that the lower pressure compressor can selectively be operated at either of at least two speeds relative to the higher pressure compressor. A method of operating a gas turbine engine is also disclosed.

### CROSS-REFERENCE TO RELATED APPLICATION

This application claims priority to U.S. Provisional Patent Application No. 62/089,307, filed Dec. 9, 2014.

### BACKGROUND OF THE INVENTION

Gas turbine engines are known and, typically, include a compressor compressing air and delivering it into a combustion section. The air is mixed with fuel and ignited. Products of this combustion pass downstream over one or more turbines, driving them to rotate. The turbines, in turn, drive the compressors.

Historically, there may be two compressors each driven by a separate turbine.

### SUMMARY OF THE INVENTION

In a featured embodiment, a gas turbine engine comprises a lower pressure compressor and a higher pressure compressor. A single turbine drives both the lower pressure compressor and the higher pressure compressor through a gear reduction. The gear reduction includes an actuator and at least two available speeds, such that the lower pressure compressor can selectively be operated at either of at least two speeds relative to the higher pressure compressor.

In another embodiment according to the previous embodiment, the higher pressure compressor has a most downstream stage which includes a centrifugal compressor delivering compressed air into a combustor section.

In another embodiment according to any the previous embodiments, the single turbine includes a radial inflow turbine receiving products of combustion.

In another embodiment according to any the previous embodiments, the actuator selectively moves at least two output gears relative to at least two compressor drive gears to selectively drive the low pressure compressor at the selected one of the at least two speeds.

In another embodiment according to any of the previous embodiments, an electronic control controls the actuator to select one of the at least two speeds.

In another embodiment according to any of the previous embodiments, the actuator includes an input gear engaged with a shaft drive gear driven by the single turbine and the input gear transmitting rotation to a gear shaft with the gear shaft driving the two output gears.

In another embodiment according to any of the previous embodiments, the actuator is pneumatic.

In another embodiment according to any of the previous embodiments, the actuator is powered by a generator.

In another embodiment according to any of the previous embodiments, the actuator includes an input gear engaged with a shaft drive gear driven by the single turbine and the input gear transmitting rotation to a gear shaft with the gear shaft driving the two output gears.

In another embodiment according to any of the previous embodiments, the single turbine includes a radial inflow turbine receiving products of combustion.

In another embodiment according to any of the previous embodiments, the actuator selectively moves at least two output gears relative to at least two compressor drive gears to selectively drive the low pressure compressor at the selected one of the at least two speeds.

In another embodiment according to any of the previous embodiments, an electronic control controls the actuator to select one of the at least two speeds.

In another embodiment according to any of the previous embodiments, the actuator selectively moves at least two output gears relative to at least two compressor drive gears drive gear teeth to selectively drive the low pressure compressor at the selected one of the at least two speeds.

In another embodiment according to any of the previous embodiments, an electronic control controls the actuator to select one of the at least two speeds.

In another embodiment according to any of the previous embodiments, the actuator includes an input gear engaged with a shaft drive gear driven by the single turbine and the input gear transmitting rotation to a gear shaft with the gear shaft driving the two output gears.

In another embodiment according to any of the previous embodiments, the actuator includes an input gear engaged with a shaft drive gear driven by the single turbine and the input gear transmitting rotation to a gear shaft with the gear shaft driving the two output gears.

In another embodiment according to any of the previous embodiments, a separate free turbine is positioned downstream of the single turbine.

In another embodiment according to any of the previous embodiments, a method of operating a gas turbine engine comprises the steps of providing a lower pressure compressor and a high pressure compressor, and providing a single turbine section, the single turbine section driving the higher pressure compressor, and driving the lower pressure compressor through a gear reduction, and the gear reduction including at least two available speeds, with an actuator actuating the gear reduction to select one of the at least two available speeds to change the speed of the lower pressure compressor relative to the speed of the higher pressure compressor.

In another embodiment according to any of the previous embodiments, the single turbine section includes a radial in-flow turbine downstream of a combustor section.

In another embodiment according to any of the previous embodiments, a separate free turbine is positioned downstream of the single turbine section.

These and other features may be best understood from the following drawings and specification.

### BRIEF DESCRIPTION OF THE DRAWINGS

FIG. 1 shows a gas turbine engine.

### DETAILED DESCRIPTION

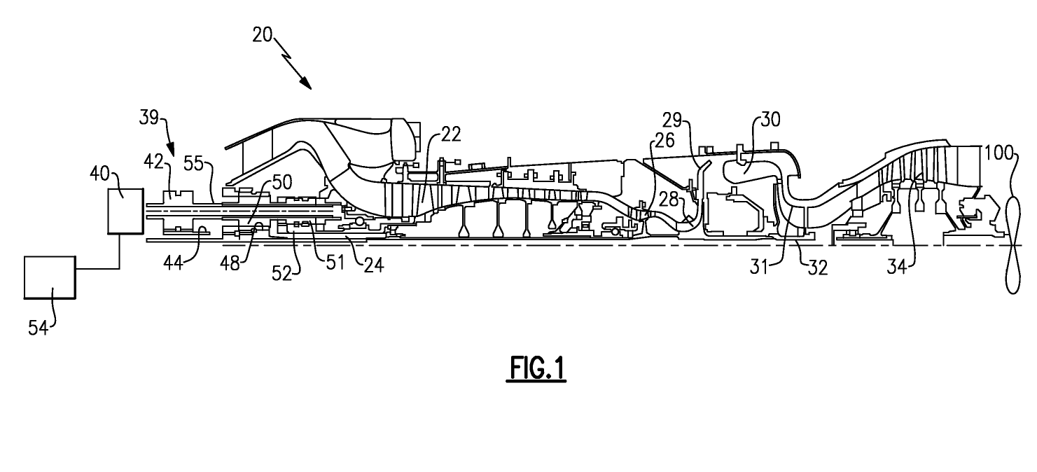

A gas turbine engine 20 is illustrated in FIG. 1. A lower pressure compressor 22 is positioned to receive and compress air. Low pressure compressor 22 is driven by a shaft 24.

A higher pressure compressor 26 ends with a centrifugal stage 28 delivering air outwardly at 29 and into a combustion section 30. In the combustion section 30, the air is mixed with fuel and ignited. Products of this combustion pass into a radial inflow turbine 31, which drives a shaft 32. Shaft 32 drives the high pressure compressor 26 at the same speed as the turbine 31.

The compressors 24/26, turbine 31, and combustor 30 could be thought of as a “gas generator.” Downstream of the turbine 31 is a separate free turbine 34 which may drive another element such as propeller 100. Alternatively, the turbine 34 could drive a fan. Further, turbine 34 could drive a shaft which extends to the left in FIG. 1 to drive a fan forward of the compressor 22.

All of these details are shown schematically.

Shaft 32 also passes through a gear reduction 39 to drive the low pressure compressor 22 at a slower speed than high pressure compressor 26. An actuator 40 is shown schematically and has an input gear 42 to receive rotation from a shaft drive gear 44, which rotates with shaft 32.

It should be understood that the drive connections are shown somewhat schematically in this FIGURE, but a worker of ordinary skill in the art would recognize how to provide appropriate connections. The actuator 40 can move the input gear 42 along an axis of rotation and selectively engage an output gear 50 with compressor drive gear 48 or engage an output gear 51 with compressor drive gear 52. The input gear 42 drives a shaft 55 which rotates gears 50 and 51. The gears are spaced such that only one output gear engages a compressor drive at any time.

The actuator 40 communicates with an electronic control 54, which may be part of an overall control for the engine.

The engine 20 has a single turbine section, which drives both the lower and higher pressure compressors 22 and 26. The radial inflow turbine 31 allows for a greater pressure expansion and, thus, the extraction of sufficient power to drive both compressors 22 and 26. Eliminating the requirement for separate turbines greatly simplifies the engine 20.

However, the two compressors 22 and 26 must have different rotational speeds. Thus, some gear reduction is desirable to reduce the speed of the low pressure compressor 22 relative to the speed of the high pressure compressor 26.

Further, the low pressure compressor 22 would desirably not always rotate at a single speed. As an example, a first speed may be utilized at half power to full power of the engine, while another speed may be desirable at lower power operation of the overall engine.

The actuator 40 could be a pneumatic actuator provided by air bleeds. Alternatively, the actuator 40 may tap power from an associated system, such as an integrated starter generator.

While two speeds are disclosed, additional speed options may be provided.

The engine 20, thus, results in a significant reduction in systems compared to a gas turbine engine requiring two turbines. This reduces complexity, cost, weight, and reduced dynamic risks.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a lower pressure compressor and a higher pressure compressor; and
a single turbine driving both said lower pressure compressor and said higher pressure compressor, said single turbine driving said lower pressure compressor through a gear reduction, and said gear reduction including an actuator and at least two available speeds, such that said lower pressure compressor can selectively be operated at either of at least two speeds relative to said higher pressure compressor.

2. The gas turbine engine as set forth in claim 1, wherein said higher pressure compressor has a most downstream stage which includes a centrifugal compressor delivering compressed air into a combustor section.

3. The gas turbine engine as set forth in claim 2, wherein said single turbine includes a radial inflow turbine receiving products of combustion.

4. The gas turbine engine as set forth in claim 3, wherein said actuator selectively moves at least two output gears relative to at least two compressor drive gears to selectively drive said low pressure compressor at said selected one of said at least two speeds.

5. The gas turbine engine as set forth in claim 4, wherein an electronic control controls said actuator to select one of said at least two speeds.

6. The gas turbine engine as set forth in claim 5, wherein said actuator includes an input gear engaged with a shaft drive gear driven by said single turbine and said input gear transmitting rotation to a gear shaft with said gear shaft driving said two output gears.

7. The gas turbine engine as set forth in claim 6, wherein said actuator is pneumatic.

8. The gas turbine engine as set forth in claim 6, wherein said actuator is powered by a generator.

9. The gas turbine engine as set forth in 4, wherein said actuator includes an input gear engaged with a shaft drive gear driven by said single turbine and said input gear transmitting rotation to a gear shaft with said gear shaft driving said two output gears.

10. The gas turbine engine as set forth in claim 1, wherein said single turbine includes a radial inflow turbine receiving products of combustion.

11. The gas turbine engine as set forth in claim 10, wherein said actuator selectively moves at least two output gears relative to at least two compressor drive gears to selectively drive said low pressure compressor at said selected one of said at least two speeds.

12. The gas turbine engine as set forth in claim 10, wherein an electronic control controls said actuator to select one of said at least two speeds.

13. The gas turbine engine as set forth in claim 1, wherein said actuator selectively moves at least two output gears relative to at least two compressor drive gears drive gear teeth to selectively drive said low pressure compressor at said selected one of said at least two speeds.

14. The gas turbine engine as set forth in claim 13, wherein an electronic control controls said actuator to select one of said at least two speeds.

15. The gas turbine engine as set forth in claim 14, wherein said actuator includes an input gear engaged with a shaft drive gear driven by said single turbine and said input gear transmitting rotation to a gear shaft with said gear shaft driving said two output gears.

16. The gas turbine engine as set forth in claim 13, wherein said actuator includes an input gear engaged with a shaft drive gear driven by said single turbine and said input gear transmitting rotation to a gear shaft with said gear shaft driving said two output gears.

17. The gas turbine engine as set forth in claim 1, wherein a separate free turbine is positioned downstream of said single turbine.

18. A method of operating a gas turbine engine comprising the steps of:
providing a lower pressure compressor and a high pressure compressor, and providing a single turbine section, said single turbine section driving said higher pressure compressor, and driving said lower pressure compressor through a gear reduction, and said gear reduction including at least two available speeds, with an actuator actuating said gear reduction to select one of said at least two available speeds to change the speed of said lower pressure compressor relative to the speed of said higher pressure compressor.

19. The method as set forth in claim 18, wherein said single turbine section includes a radial in-flow turbine downstream of a combustor section.

20. The method as set forth in claim 18, wherein a separate free turbine is positioned downstream of said single turbine section.
